(19) United States
(12) Patent Application Publication
(10) Pub. No.: US 2018/0160707 A1
(43) Pub. Date: Jun. 14, 2018

(54) Method for Producing Non-Fried, Instantly-Restored Container-Type Dry Noodles

(71) Applicant: CJ Cheiljedang Corporation, Seoul (KR)

(72) Inventors: Young Joo HAN, Seoul (KR); Gu Sik CHUNG, Gyeonggi-do (KR); Seung Ho WOO, Seoul (KR); Soon Hee KWON, Gyeonggi-do (KR); Eun Yi KIM, Gyeonggi-do (KR)

(21) Appl. No.: 15/559,482

(22) PCT Filed: Mar. 16, 2016
(86) PCT No.: PCT/KR2016/002624

§ 371 Date: Sep. 19, 2017

(30) Foreign Application Priority Data
Mar. 31, 2015 (KR) 10-2015-0045538

(51) Int. Cl. A23L 7/113; A23L 5/40

(52) U.S. Cl. CPC A23L 7/113; A23V 2002/00; A23L 5/40

(57) ABSTRACT

The present invention relates to a method for producing cup-type non-fried dry instant noodles. More specifically, the present invention relates to a method for producing cup-type dry instant needles, comprising the steps of: (a) mixing and kneading a raw material to make a noodle sheet; (b) making noodle strands from the noodle sheet, and waving the noodle strands; (c) steaming the waved noodle strands to make steamed noodles; (d) cutting and weighing the steamed noodles, and placing the weighed steamed noodles in a drying box; and (e) drying the placed steamed noodles in the drying box at a high temperature of 140 to 180° C. for 2 to 5 minutes.

### TECHNICAL FIELD

The present invention relates to a method for producing cup-type non-fried dry instant noodles, and more particularly to a method for producing cup-type dry instant noodles, in the dry instant noodles have a low caloric content and a texture similar to that of fried instant noodles because of being produced without frying in oil, and can be rehydrated within a short time.

### BACKGROUND ART

Typical cup-type instant noodles which are distributed in the market include fried instant noodles produced by frying noodles in oil to replace the water of the noodles with oil, non-fried instant noodles produced by drying gelatinized cooked noodles to a certain water content or less, and processed noodles produced by gelatinizing noodle strands, and subjecting the gelatinized noodles strands to acid treatment to lower the pH and control microorganisms, followed by hermetic sealing packaging and heat sterilization.

The fried instant noodles have a good flavor and texture, because they are produced by frying in oil. However, the fried instant noodles have a high caloric content due to their high oil content, and generate an odor due to acidification of oil contained therein during storage, indicating that they are difficult to store for a long period of time.

The non-fried instant noodles are produced without frying in oil, and thus have a low oil content and a low caloric content and taste plain. However, the non-fried instant noodles are obtained by a hot-air drying process for a long time, which shrinks the noodles to reduce the porosity of the noodles. For this reason, soup do not easily penetrate the non-fried instant noodles, and thus the noodles do not well harmonize with the noodles. In addition, the non-fried instant noodles are not rehydrated in a rapid and uniform manner, and thus have a poor texture.

The processed noodles are produced without frying in oil, and thus have a low oil content and can be stored for a long period of time. However, because the processed noodles had been treated with acid to lower the pH in order to inhibit microbial growth, they taste sour. In addition, for production of the processed noodles, noodles having a high water content are packaged and sterilized by heating, and water in the noodles reaches equilibrium. For this reason, the processed noodles have a poor texture.

Meanwhile, in the prior art, studies have been made on methods in which oils such as edible oil or powdery oil are mixed with raw materials or applied or spread onto noodle sheets or noodle strands, followed by drying, in order to improve the flavor and texture of instant noodles.

For example, Korean Patent No. 10-1252982 discloses a method for producing instant noodles having a fried instant noodle flavor and texture and a low caloric content, the method comprising adding edible oil to a noodle dough material and applying eatable oil to raw noodle strands.

However, in this method, edible oil is added to raw material powder and is also applied to raw noodle strands. Thus, the noodles can necessarily have a caloric content higher than that of non-fried instant noodles due to oil contained therein, and may possibly generate an odor due to acidification of oil contained therein.

Accordingly, there is a need for a method for producing a new type of noodle product which has a texture similar to that of fried instant noodles without having to add oil or powdery oil to raw material powder or to apply oil or powdery oil to noodle strands, and which can well harmonize with soup upon eating so as to satisfy the demands of consumers who seek health, convenience and taste.

### PRIOR ART DOCUMENTS

### Patent Documents

(Patent Document 1) KR10-1252982 B1 (published on Apr. 15, 2013).

### Disclosure

### Technical Problem

The present invention has been made in order to solve the above-described problems, and it is an object of the present invention to provide a method for producing cup-type dry instant noodles, in which noodles are dried uniformly by hot air at high temperature for a short time without frying in oil, so that the produced dry instant noodles may have an excellent texture and may also be rehydrated within a short time.

### Technical Solution

To achieve the above object, the present invention provides a method for producing cup-type non-fried dry instant noodles, comprising the steps of:

(a) mixing and kneading a raw material to make a noodle sheet;

(b) making noodle strands from the noodle sheet, and waving the noodle strands;

(c) steaming the waved noodle strands to make steamed noodles;

(d) cutting and weighing the steamed noodles, and placing the weighed steamed noodles in a drying box; and

(e) drying the placed steamed noodles in the drying box at a high temperature of 140 to 180° C. for 2 to 5 minutes.

### Advantageous Effects

In the method for producing cup-type dry instant noodles according to the present invention, noodles are not fried in oil. Thus, the produced instant noodles are less concerned about acidification of oil, and have a low caloric content and a texture similar to that of fried instant noodles. Furthermore, in the method of the present invention, noodles are dried for a short time, and thus the produced dry instant noodles have a number of pores formed therein. Thus, soup can easily penetrate the noodles so that the noodles may be eaten within a short time after hot water is added thereto.

### Mode for Invention

Hereinafter, the present invention will be described in detail.

In one aspect, the present invention provides a method for producing cup-type non-fried dry instant noodles, comprising the steps of:

(a) mixing and kneading a raw material to make a noodle sheet;

(b) making noodle strands from the noodle sheet, and waving the noodle strands;

(c) steaming the waved noodle strands to make steamed noodles;

(d) cutting and weighing the steamed noodles, and placing the weighed steamed noodles in a drying box; and

(e) drying the placed steamed noodles in the drying chamber at a high temperature of 140 to 180° C. for 2 to 5 minutes.

The raw material that is used in the present invention may be any material that is generally used in production of noodles. The raw material comprises raw material powder, and may further comprise other additives.

The raw material powder may comprise one or more of flour and starch, but is not limited thereto.

The flour that is used in the present invention may be one or more of high gluten flour (strong flour), medium flour (all-purpose flour), weak flour, and the like. Preferably, the flour may be high gluten flour.

The starch that is used in the present invention may be one or more of sweet potato starch, corn starch, tapioca starch, potato starch, wheat starch, pea starch, and modified starches thereof. Preferably, starch having low gelatinization temperature may be used. More preferably, the starch is modified potato starch.

When modified potato starch is used, it is gelatinized faster than flour, because it has a gelatinization temperature lower than flour. Thus, as the content of the starch increases, the drying time and rehydration of noodles can be shortened.

In addition, a mixture for making noodles is required to contain a certain amount or more of protein (gluten). High gluten flour, medium flour and weak flour have different protein contents. Thus, when medium flour and weak flour are used, the amount of starch added decreases, and thus the drying time and rehydration of noodles will increase.

For this reason, in order to shorten the drying time and rehydration time of noodles, it is required to increase the content of starch having low gelatinization temperature in the mixture. However, in this case, the amount of protein (gluten) may be insufficient, so that a noodle sheet may not be easily formed.

Thus, in order to increase the content of starch while enabling a noodle sheet to be easily formed, it is preferable to use high gluten flour having a high protein (gluten) content.

The raw material powder may comprise 60 to 95 wt % of flour and 5 to 40 wt % of starch.

In a preferred embodiment of the present invention, a mixture of 65 wt % of flour (high gluten flour) and 35 wt % of acetic acid-modified potato starch having low gelatinization temperature was used as the raw material powder. In this case, the drying time of prepared noodles was shortened, and thus noodles having a number of pores due to uniform drying for a short time could be obtained. This had positive effects on the rehydration time and sensory properties of noodles after hot water was poured therein.

To change the texture of noodles, the raw material powder may further comprise, in addition to the flour or starch, grain powder. The grain powder may be one or more of barley powder, sorghum powder, rice powder, bean powder, red-bean powder, oat powder, rye powder, buckwheat powder, etc.

Additives other than the raw material powder include an alkaline agent, a colorant and the like, which may be used alone or in a mixture of two or more depending on the texture and intended appearance of noodles. These additives may be added as powder together with the raw material powder, or may be added as solution or suspension in water.

In step (a), the raw material powder and various additives are mixed uniformly using a mixer for 20 minutes or less, preferably 5 to 10 minutes, to form a dough. The dough is formed into a noodle sheet.

Water is added to the mixed raw material which is then kneaded for 10 to 25 minutes. Herein, the water is preferably added in an amount of 35 wt % or less based on the total weight of the mixed raw material.

Two noodle sheets are prepared from the dough, and then passed through a combination machine to make one noodle sheet. Then, the noodle sheet is subjected to 4 to 7 rolling steps in which the thickness thereof is gradually reduced. Herein, the thickness of the noodle sheet may be adjusted depending on desired noodles, and is not particularly limited. Preferably, the thickness of the noodle sheet may be selected from among 0.9 mm, 1.1 mm, 1.15 mm, and 1.25 mm.

In step (b), the noodle sheet is made into noodle strands, and the noodle strands are waved.

The noodle sheet obtained in step (a) is rolled to a desired thickness and passed through a slitter to make noodle strands. The noodle strands are waved by passage through a waving box.

In a preferred embodiment, the noodle strands are made to have a width of 3 mm and a thickness of 0.9 mm.

The waves serve to prevent the noodle strands from sticking to one another and to promote loosing of the noodle strands during cooking or eating or rehydration of the noodle strands in hot water.

In step (c), the weaved noodle strands are steamed to make steamed noodles.

The steaming may be performed according to a conventional method that is used to produce instant noodles. In a preferred embodiment, the steaming comprises maintaining the waved noodle strands in a steam tunnel box at 80 to 100° C. for 2 to 9 minutes so as to gelatinize 60 to 95% of the noodle strands.

In step (d), the steamed noodles obtained in step (c) are cut, weighed, and placed in a drying box.

The steamed noodles may be weighed and cut to “one meal” amount while tension is applied thereto, and the cut noodles may be placed in a drying box. The “one meal” amount and cutting length of the steamed noodles may be adjusted depending on the kind of desired noodle product. Generally, the length of the noodles may be 20 to 30 cm.

The drying box may have a cylindrical or rectangular prism shape, and the shape of the drying box may be selected depending on the shape of a container for the desired noodle product. The drying box may have a number of ball- or net-shaped air holes formed therein. Preferably, the air holes may account for the area of the drying box. This drying box is preferable, because it can increase the efficiency of drying.

In step (e), the placed steamed noodles are dried in the drying box at a high temperature of 140 to 180° C. for 2 to 5 minutes.

In a preferred embodiment, the drying process is performed at 170° C. for 4 minutes.

If the temperature of hot air used in the drying process is as low as 140° C., the swollen state of the noodles becomes poor. In addition, in this case, uniform drying cannot be achieved, and a drying time of 5 minutes or more will be required. If the drying time is lengthy as described above, shrinkage of the noodles will occur, and uniform pores will not be formed. Thus, the cooking time of the noodles will also be lengthy, and source will not easily penetrate the noodles.

If the temperature of hot is as high as 180° C., a portion of the noodles will be excessively dried to become brown, or will not be dried, indicating that the noodles will not be uniformly dried.

When the noodles are dried uniformly by hot air at high temperature for a short time as described above, water contained in the noodles is evaporated uniformly so that a number of pores will be formed uniformly throughout the noodles. Thus, in this case, sauce and soup can uniformly penetrate the pores during cooking, and thus the noodles can well harmonize with the source.

The dried noodles obtained by the drying process preferably have a water content of 6% to 10%.

The noodles, dried by the above-described drying process for a short time, are cooled rapidly at low temperature and packaged.

The kind of cup-type dry instant noodles produced according to the method of the present invention is not particularly limited, and may be any instant noodles known to those skilled in the art. Examples of the cup-type dry instant noodles include instant Udon noodles, instant Soba noodles, instant Chinese noodles, instant spaghetti, and the like.

Hereinafter, the present invention will be described in detail with reference to examples. It is to be understood, however, that these examples are for illustrative purposes only and are not intended to limit the scope of the present invention. In the following examples, the term “%” means “wt %” unless otherwise specified.

### EXAMPLES

### Example 1

9.5 kg of wheat flour (medium flour) and 0.5 kg of acetic acid-modified potato starch were mixed in a mixer, and about 35 L of water was added to the mixture which was then stirred in the mixer for 20 minutes or less to obtain a dough.

In a noodle sheet forming machine and a combination machine, a noodle sheet was made from the dough and passed through a 5-stage roller to make noodle strands, each having a width of 3 mm and a thickness of 1.15 mm. The noodle strands were waved by passage through a waving box.

The waved noodle strands were steamed for 10 minutes or less. The steamed noodle strands were stretched by application of tension and cut to a desired length (25-30 cm). The cut noodle strands were placed in a drying box.

In the drying box, the noodles were dried rapidly by hot air at a high temperature of 170° C. or below for 4 minutes (Philips Airfryer, Airstone Technology).

Next, the dried noodles were cooled at room temperature and packaged, thereby producing cup-type dry instant noodles.

### Example 2

Dry instant noodles were produced in the same manner as described in Example 1, except that 6.5 kg of wheat flour (high gluten flour) and 3.5 kg of acetic acid-modified potato starch were used and noodles were prepared to have a width of 3 mm and a thickness of 0.9 mm.

### Example 3

Dry instant noodles were produced in the same manner as described in Example 1, except that 6.5 kg of wheat flour (high gluten flour) and 3.5 kg of acetic acid-modified potato starch were used and noodles were prepared to have a width of 3.3 mm and a thickness of 1.1 mm.

### Example 4

Dry instant noodles were produced in the same manner as described in Example 1, except that 6.5 kg of wheat flour (high gluten flour) and 3.5 kg of acetic acid-modified potato starch were used and noodles were prepared to have a width of 3.3 mm and a thickness of 1.25 mm.

### Test Example 1

### Evaluation of Rehydration Ability of Produced Dry Noodles

Each of the instant dry noodles produced in Examples 1 to 4 was placed in a container, and hot water was poured therein. Then, the rehydration time of the noodles was measured. Because cup-type instant noodles may be eaten after rehydration, the time point at which the dry noodles completely get loose was used as the time point of completion of rehydration. Based on this time point of completion of rehydration, the rehydration time was measured, and the results are shown in Table 1.

TABLE 1

| Dry noodles | Rehydration time |
|---|---|
| Example 1 (width: 3 mm, and thickness: 1.15 mm) | About 5 min |
| Example 2 (width: 3 mm, and thickness: 0.9 mm) | About 3 min |
| Example 3(width: 3.3 mm, and thickness: 1.1 mm) | About 4 min 30 sec |
| Example 4 (width: 3.3 mm, and thickness: 1.25 mm) | About 5 min 30 sec |

As can be seen in Table 1 above, the time taken for the dry noodles of Example 1 to be instantly rehydrated after addition of hot water was 5 minutes. Even after rehydration, the noodles of Example 1 well harmonized with the sauce without being mushy and soggy, and had a soft texture.

The time taken for the dry noodles of Example 2 to be instantly rehydrated after addition of hot water was 3 minutes. Even after rehydration, the noodles of Example 2 well harmonized with the sauce without being mushy and soggy, and had a good texture.

The time taken for the dry noodles of Example 3 to be instantly rehydrated after addition of hot water was minutes and 30 seconds. Even after rehydration, the noodles of Example 3 well harmonized with the sauce without being mushy and soggy, and had a better texture than the dry noodles of Example 1.

The time taken for the dry noodles of Example 4 to be instantly rehydrated after addition of hot water was 5 minutes and 30 seconds. Even after rehydration, the noodles of Example 4 well harmonized with the sauce without being mushy and soggy, and had a good texture.

Taking the results of Examples and the Test Example together, it can be seen that the wheat flour (high gluten flour) used in Examples 2 to 4, when used to cup-type dry instant noodles, provides a better texture than the wheat flour (medium flour) used in Example 1.

In addition, from the results of Test Example 1, it can be seen that the dry noodles of Examples 2 to 4, prepared to have a width of 3 mm and a thickness of 0.9 mm, a width of 3.3 mm and a thickness of 1.1 mm, and a width of 3.3 mm and a thickness of 1.25 mm, respectively, were 3 min, 4 min and 30 sec, and 5 min and 30 sec, respectively, indicating that the rehydration time of the noodles after addition of hot water decreases as the thickness and width of the noodles decrease. This suggests that the width and thickness of noodles may be adjusted depending on the texture and concept of the desired type of noodles.

1. A method for producing cup-type non-fried dry instant noodles, comprising the steps of:
(a) mixing and kneading a raw material to make a noodle sheet;
(b) making noodle strands from the noodle sheet, and waving the noodle strands;
(c) steaming the waved noodle strands to make steamed noodles;
(d) cutting and weighing the steamed noodles, and placing the weighed steamed noodles in a drying box; and
(e) drying the placed steamed noodles in the drying box at a high temperature of 140 to 180° C. for 2 to 5 minutes.

2. The method of claim 1, wherein the raw material comprises a raw material powder comprising one or more of flour and starch.

3. The method of claim 2, wherein the raw material further comprises, in addition to the raw material powder, an additive selected from among an alkaline agent and a colorant.

4. The method of claim 2, wherein the flour is one or more selected from among high gluten flour, medium flour and weak flour.

5. The method of claim 4, wherein the flour is high gluten flour.

6. The method of claim 2, wherein the starch is one or more selected from among sweet potato starch, corn starch, tapioca starch, potato starch, wheat starch, pea starch, and modified starches thereof.

7. The method of claim 2, wherein the raw material powder further comprises, in addition to the flour or the starch, one or more selected from among barley powder, sorghum powder, rice powder, bean powder, red-bean powder, oat powder, rye powder, and buckwheat powder.

8. The method of claim 1, wherein the steaming in step (c) comprises maintaining the waved noodle strands in a steam tunnel box at 80 to 100° C. for 2 to 9 minutes so as to gelatinize 60 to 95% of the noodle strands.

9. The method of claim 1, wherein the dry noodles resulting from the drying in step (e) has a water content of 6 to 10%.

10. The method of claim 1, wherein the raw material in step (a) comprises 65 wt % of high gluten flour and 35 wt % of starch.
